(19) United States
(12) Patent Application Publication
(10) Pub. No.: US 2026/0277152 A1
(43) Pub. Date: Sep. 17, 2026

(54) IMAGE FORMING APPARATUS

(71) Applicant: KYOCERA Document Solutions Inc., Osaka (JP)

(72) Inventor: Seia FUJII, Osaka (JP)

(73) Assignee: KYOCERA Document Solutions Inc., Osaka (JP)

(21) Appl. No.: 19/561,860

(22) Filed: Mar. 10, 2026

(30) Foreign Application Priority Data
Mar. 13, 2025 (JP) 2025-040109

(51) Int. Cl. G03G 21/16; G03G 15/20

(52) U.S. Cl. CPC G03G 21/1647; G03G 15/2032; G03G 15/2064; G03G 2221/1639; G03G 2221/1657

(57) ABSTRACT

A fixing device includes a fixing support member supporting rotatably a pressuring roller, a fixing-side joint member supported rotatably and slidably in an axial direction on the fixing support member to transmits rotational force to the pressuring roller, and a lever member supported rotatably on the fixing-side joint member and slidably in the axial direction integrally with the fixing-side joint member. When the lever member rotates from one-side to other-side while contacting the inclined surface portion of the fixing support member, the fixing-side joint member is axially slidden from the inside to the outside and is positioned at a connected position to a main body-side joint member. When the lever member rotates from other-side of one-side while contacting the inclined surface portion, the fixing-side joint member is axially slidden from the outside to the inside and is positioned at a separated position to the main body-side joint member.

### INCORPORATION BY REFERENCE

This application is based on and claims the benefit of priority from Japanese Patent application No. 2025-040109 filed on Mar. 13, 2025, the entire contents of which are incorporated herein by reference.

### BACKGROUND

The present disclosure relates to a fixing device for fixing a toner image onto a medium and an image forming apparatus.

An electrophotographic image forming apparatus includes a fixing unit for fixing a toner image onto a sheet. A conventional fixing unit comprises a heating unit and a pressuring roller forming a fixing nip, wherein the pressuring roller is rotatably driven. Furthermore, the fixing unit includes a pressure applying section that applies pressure to the fixing nip section gripping and transporting the sheet, and a pressure release cam that acts on the pressure applying section to release the pressure applied to the fixing nip section. In a situation of being mounted on a main body of the image forming apparatus, the pressure release cam rotates via a coupling section to switch the fixing nip section between a pressurized state and a pressure released state. A phase difference between the pressurized state and the pressure released state is set to 180 degrees to allow the fixing unit to be attached to or detached from the main body of the image forming apparatus regardless of whether the fixing nip is in the pressurized state or the pressure released state.

In the above-described fixing unit, the fixing unit could not be attached to or detached from the main body of the image forming apparatus unless the pressure release cam was aligned to a specific phase. Furthermore, when attaching or detaching the fixing unit to the main body of the image forming apparatus, it was necessary to interrupt transmission of driving force (rotational force) to the pressuring roller. However, the above-described fixing unit did not sufficiently consider structure (means) for transmitting or interrupting driving force to the pressuring roller, making it difficult to easily switch between transmitting and interrupting driving force to the pressuring roller.

### SUMMARY

A fixing device in accordance with the present disclosure includes a fixing member, a pressuring member, a fixing support member, a fixing side joint member and a lever member. The fixing member heats a toner on a medium while rotating around its axis. The pressuring member, that forms a pressuring area between the fixing member and the pressuring member, pressures the toner on the medium passing through the pressuring area while rotating around its axis. The fixing support member supports rotatably the fixing member and the pressuring member. The fixing side joint member is supported rotatably and slidably in an axial direction on the fixing support member, is connected to a drive source via a main body side joint member, and transmits rotational force to either the fixing member or the pressuring member. The lever member is supported rotatably on the fixing side joint member and slidable in the axial direction integrally with the fixing side joint member. The fixing support member has an inclined surface portion that is inclined outward in the axial direction from one side of other side in a rotation direction. When the lever member rotates from the one side to the other side in the rotation direction while contacting the inclined surface portion, the fixing side joint member is slidden from an inner side to an outer side in the axial direction and is positioned at a connected position where it is connected to the main body side joint member. When the lever member rotates from the other side of the one side in the rotation direction while contacting the inclined surface portion, the fixing side joint member is slidden from the outer side to the inner side in the axial direction and is positioned at a separated position where it is separated to the main body side joint member.

An image forming apparatus in accordance with the present disclosure includes the above-described fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic diagram (a side view) showing internal structure of an image forming apparatus according to an embodiment of the present disclosure.

FIG. 2 is a perspective view showing a fixing device according to the embodiment of the present disclosure.

FIG. 3 is a perspective view showing a fixing belt and a pressuring roller of the fixing device according to the embodiment of the present disclosure.

FIG. 4 is a cross-sectional view along a IV-IV line of FIG. 3.

FIG. 5 is a perspective view showing a left end portion of the fixing frame of the fixing device according to the embodiment of the present disclosure.

FIG. 6 is a perspective view showing a fixing side joint member of a fixing side drive transmitting section of the fixing device according to the embodiment of the present disclosure.

FIG. 7 is a perspective view showing a lever member of the fixing side drive transmitting section of the fixing device according to the embodiment of the present disclosure.

FIG. 8 is a perspective view showing the fixing side joint member and the lever member of the fixing side drive transmitting section of the fixing device according to the embodiment of the present disclosure.

FIG. 9 is a cross-sectional view showing the fixing side joint member and the lever member of the fixing side drive transmitting section of the fixing device according to the embodiment of the present disclosure.

FIG. 10 is a perspective view showing the fixing side drive transmitting section, in a state where the fixing side joint member is separated from a main body side joint member, of the fixing device according to the embodiment of the present disclosure.

FIG. 11 is a perspective view showing the fixing side drive transmitting section, in a state where the lever member is positioned in a separated position, of the fixing device according to the embodiment of the present disclosure.

FIG. 12 is a perspective view showing the fixing side drive transmitting section, in a state where the fixing side joint member is connected to the main body side joint member, of the fixing device according to the embodiment of the present disclosure.

FIG. 13 is a perspective view showing the fixing side drive transmitting section, in a state where the lever member is positioned in a connected position, of the fixing device according to the embodiment of the present disclosure.

### DETAILED DESCRIPTION

The embodiments of the present disclosure will now be described with reference to the accompanying drawings. In the drawings, Fr, Rr, L, R, U, and D indicate a front side, a rear side, a left side, a right side, an up side, and a down side, respectively. Furthermore, front and rear directions, left and right directions (an axial direction), and up and down directions are mutually orthogonal. Although terms indicating direction or position are used herein, such terms are used for convenience of explanation and do not limit the technical scope of the present disclosure. Also, in each figure, shapes, dimensions, angles, and others of each component are not exact and are schematized for explanatory purposes.

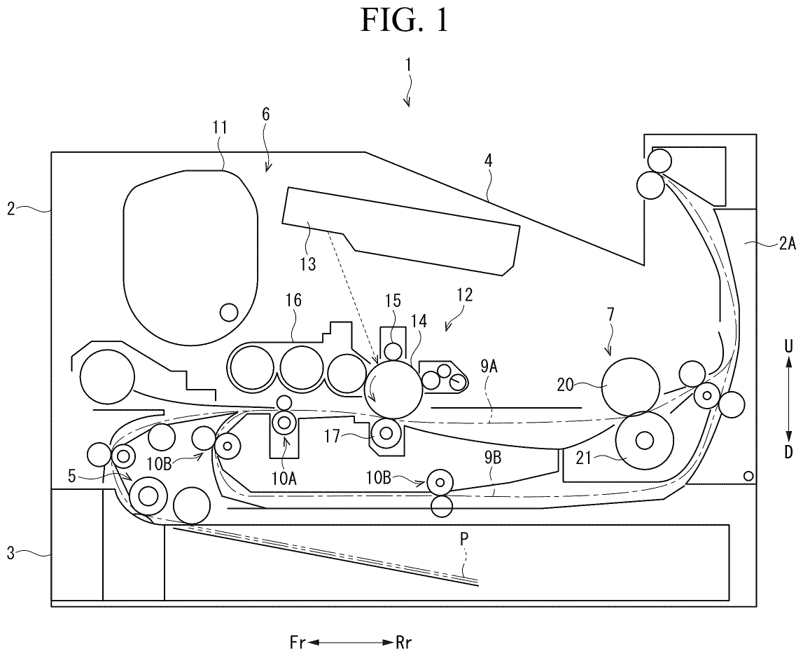

Referring to FIG. 1, an image forming apparatus 1 according to the embodiment will be described. FIG. 1 is a schematic diagram (a side view) showing the image forming apparatus 1.

The image forming apparatus 1 is an electrophotographic printer. The image forming apparatus 1 includes a main body 2 having a substantially rectangular prism shaped exterior. At the bottom portion of the main body 2, a sheet feeding cartridge 3, for example, for storing sheets P (mediums), is detachably provided. At the top surface of the main body 2, an ejection tray 4 is provided. Further, the main body 2 includes a metal frame and synthetic resin components fixed to this frame. Furthermore, the sheet P as an example of the medium is not limited to a paper and may also be a resin sheet or the like. In this specification, the terms “upstream” and “downstream” and similar terms refer to the “upstream” and “downstream” in a conveying direction of the sheet P and similar concepts.

The image forming apparatus 1 comprises a sheet feeding device 5, an imaging device 6, and a fixing device 7. The sheet feeding device 5 is provided at an upstream end portion of a conveyance path 9A extending from the sheet feeding cartridge 3 to the ejection tray 4, and feeds the sheet P stored in the sheet feeding cartridge 3 one by one into the conveyance path 9A. The imaging device 6 is provided at a middle portion of the conveyance path 9A and forms a toner image on the conveyed sheet P. The fixing device 7 is provided at a downstream side of the conveyance path 9A and thermally fixes the toner image onto the sheet P.

On the conveyance path 9A, a pair of register rollers 10A are provided to temporarily block the conveyed sheet P and to correct its skew. Below the conveyance path 9A, an inverted conveyance path 9B branching off at a downstream side of the conveyance path 9A and rejoining at an upstream side of the conveyance path 9A is provided. On the inverted conveyance path 9B, a plurality of pairs of conveying rollers 10B conveying the sheet P are provided.

The imaging device 6 comprises a toner container 11, a drum unit 12, and an optical scanning device 13. The toner container 11 is positioned at a front upper portion of the main body 2 and stores, for example, a black toner (a developer). The drum unit 12 comprises a photosensitive drum 14, a charging device 15, a developing device 16, and a transferring roller 17. The photosensitive drum 14 is formed in a substantially cylindrical shape and is driven by a motor (not shown) so as to rotate around its axis. The charging device 15, the developing device 16, and the transferring roller 17 are arranged around the photosensitive drum 14 in an order of image forming process. The transferring roller 17 contacts the photosensitive drum 14 from below to form a transferring nip. The optical scanning device 13 is positioned above the photosensitive drum 14 and emits scanning light toward the surface of the photosensitive drum 14.

### Image Forming Process

A control unit (not shown), which centrally controls the image forming apparatus 1, executes image forming process on the basis of image data inputted from an external terminal, as follows.

The charging device 15 charges a surface of the photosensitive drum 14. The optical scanning device 13 emits scanning light based on the image data to form an electrostatic latent image on the photosensitive drum 14. The developing device 16 develops the toner image on the photosensitive drum 14 using the toner supplied from the toner container 11. The sheet feeding device 5 feeds the sheet P from the sheet feeding cartridge 3 one by one into the conveyance path 9A. The sheet P is conveyed along the conveyance path 9A, undergoes skew correction by the pair of register rollers 10A, and enters the transferring nip. The transfer roller 17 transfers the toner image from the photosensitive drum 14 onto a surface of the sheet P passing through the transferring nip. The fixing device 7 thermally fixes the toner image onto the sheet P. For single sided printing, the sheet P that has passed through the fixing device 7 is ejected onto the ejection tray 4.

For duplex printing, the sheet P that has passed through the fixing device 7 is switched back at a downstream end portion of the conveyance path 9A and is sent to the inverted conveyance path 9B. The sheet P is conveyed by the pairs of conveying rollers 10B, returned from the inverted conveyance path 9B to the conveyance path 9A again, and sent to the transferring nip after skew correction by the pair of register rollers 10A. Subsequently, the toner image is transferred onto the sheet P, thermally fixed, and the double sided printed sheet P is ejected into the ejection tray 4.

### Fixing Device

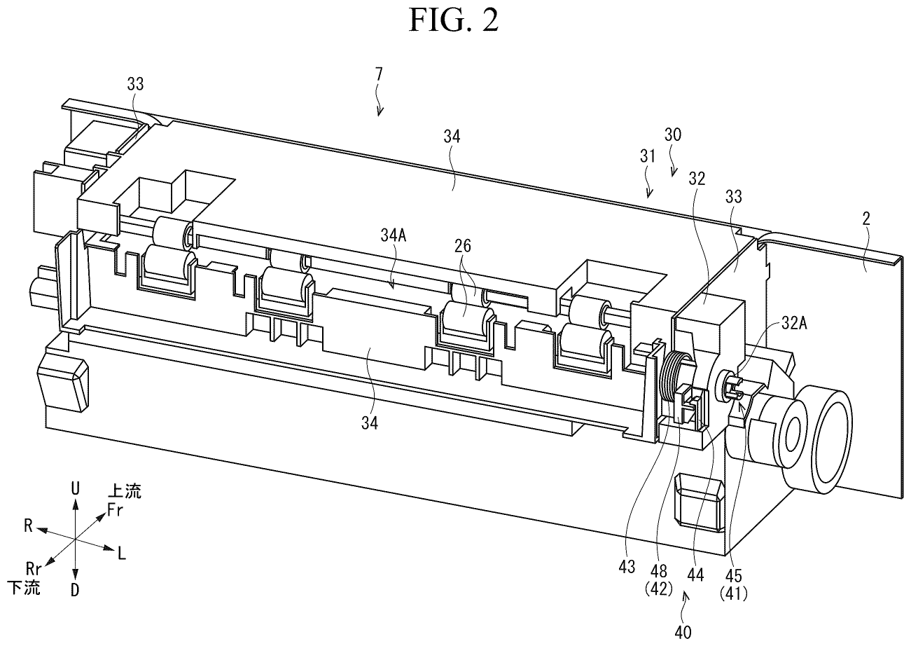

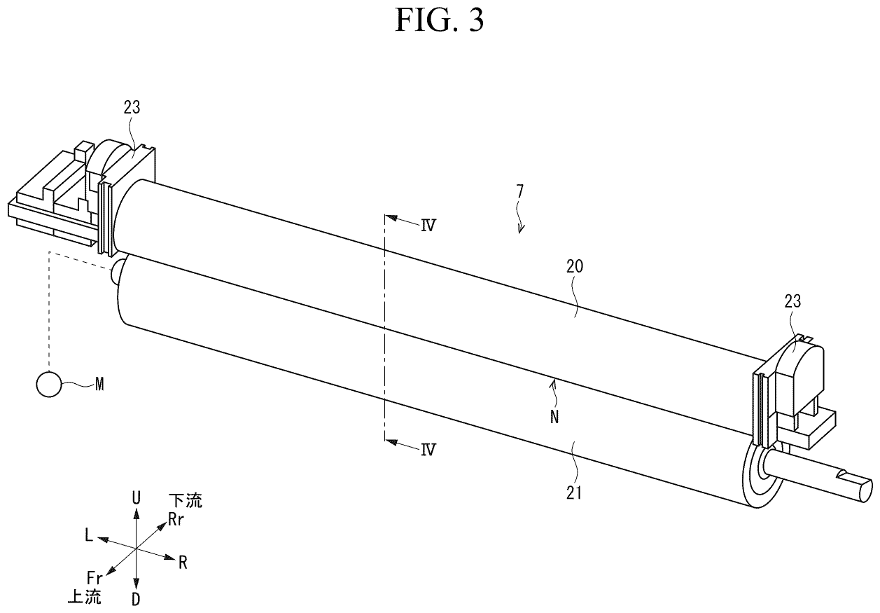

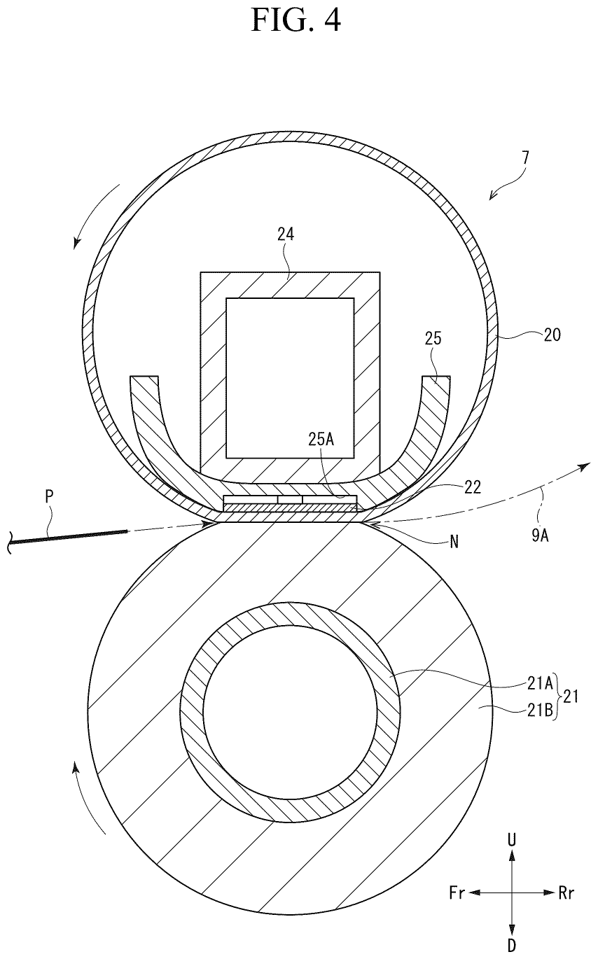

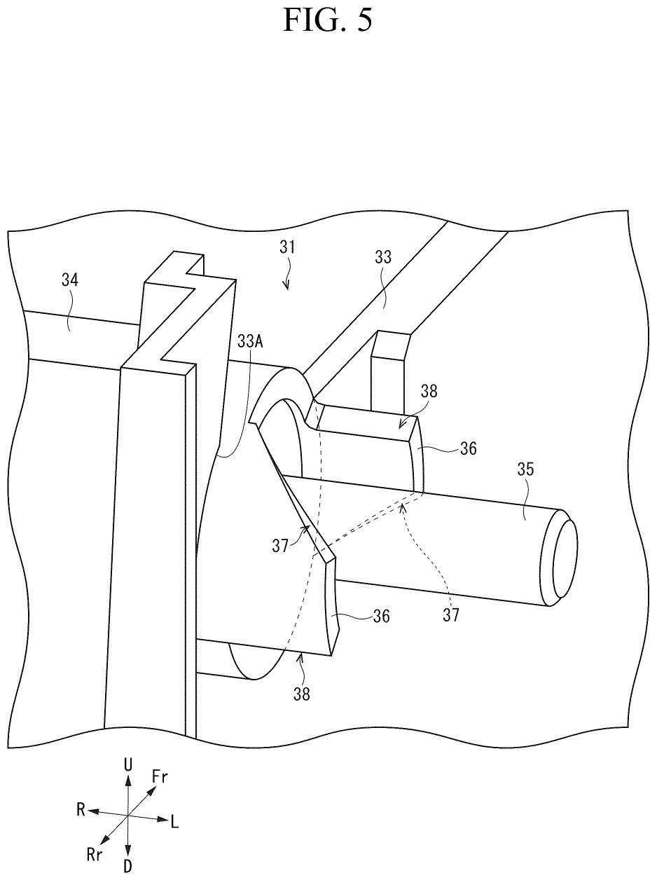

Next, with reference to FIGS. 2-5, the fixing device 7 will be described. FIG. 2 is a perspective view showing the fixing device 7. FIG. 3 is a perspective view showing a fixing belt 20 and a pressuring roller 21 of the fixing device 7. FIG. 4 is a sectional view along a IV-IV line of FIG. 3. FIG. 5 is a perspective view showing a left end portion of a fixing frame 31 of the fixing device 7.

As shown in FIGS. 2-4, the fixing device 7 comprises a fixing belt 20, the pressuring roller 21, a heater 22, a fixing support member 30, and a fixing side drive transmitting section 40.

### Fixing Belt

The Fixing belt 20 as one example of a heating member is an endless belt formed into a substantially cylindrical shape elongated in the left and right directions (the axial direction). The Fixing belt 20 is formed from a material possessing heat resistance and flexibility (a polymer resin or metal, or a combination of a polymer resin and metal). A pair of belt retaining members 23 (see FIG. 3) are inserted into both left and right end portions of the fixing belt 20. The pair of belt retaining members 23 guide the fixing belt 20 so that it can rotate around its axis while retaining it in a substantially cylindrical shape.

As shown in FIG. 4, in the space enclosed by the fixing belt 20, a supporting member 24 and a pressure receiving member 25 are provided. The supporting member 24 is formed, for example, from a metal material, such as stainless steel, into a roughly angular cylindrical shape extending in the left and right directions (the axial direction) and is supported between the belt retaining members 23. The pressure receiving member 25 is fixed to a lower portion of the supporting member 24. The pressure receiving member 25 is formed, for example, from a synthetic resin possessing heat resistance and wear resistance into a substantially semicylindrical shape extending in the left and right directions. The pressure receiving member 25 is curved along an inner surface of the fixing belt 20 and contacts a lower side (a side of a pressuring area N) of the inner surface of the fixing belt 20. In a lower portion of the pressure receiving member 25, a fitting portion 25A, into which the heater 22 is fitted, is recessed.

### Pressuring Roller

As shown in FIGS. 3 and 4, the pressuring roller 21 as one example of a pressuring member is formed into a roughly cylindrical shape extending in the left and right directions. The pressuring roller 21 comprises a metal core 21A and an elastic layer 21B, such as a silicone sponge, laminated onto its outer peripheral surface (see FIG. 4). As described in detail later, to a left end portion of the pressuring roller 21 (the core 21A), a fixing side drive transmitting section 40 is connected (see FIG. 2). The pressuring roller 21 is connected to a drive motor M (a drive source) via the fixing side drive transmitting section 40 and others, and rotates around its axis under driving force (rotational force) from the drive motor M. The pressuring roller 21 contacts the fixing belt 20 from below to form the pressuring area N between itself and the fixing belt 20. As the sheet P passes through the pressuring area N, the toner image is fixed onto the sheet P. Note that the pressuring area N refers to an area extending from an upstream position where pressure is 0 Pa, through a position where pressure is applied, to a downstream position where the pressure again becomes 0 Pa.

### Heater

As shown in FIG. 4, the heater 22 is fitted into the fitting portion 25A of the pressure receiving member 25. The heater 22 comprises a substrate formed from an insulator, such as ceramic and a plurality of heating resistors formed on the substrate. The heater 22 contacts the inner surface of the fixing belt 20 facing the pressuring area N. It generates heat when supplied with power, thereby heating the fixing belt 20. Note that the heater 22 is not limited to a plate shape, it may be, for example, a halogen heater (not shown).

### Fixing Support Member

As shown in FIG. 2, the fixing support member 30 comprises a fixing frame 31 and a fixing holder 32.

### Fixing Frame

The fixing frame 31 comprises a pair of side plate frames 33 formed from a metal material, such as stainless steel, and a support frame 34 formed from a synthetic resin possessing heat resistance and wear resistance. The pair of side plate frames 33 are arranged spaced apart in the left and right directions and are mounted on the main body 2. Between the side plate frames 33, the fixing belt 20 and the pressuring roller 21 are supported. The fixing frame 31 (the pair of side plate frames 33) rotatably supports the fixing belt 20 and the pressuring roller 21. The fixing belt 20 is supported on the fixing frame 31 via the pair of belt retaining members 23. The support frame 34 is supported between the side plate frames 33 and covers most of the fixing belt 20 and the pressuring roller 21. At the front of the support frame 34, an entry port (not shown) for entering the sheet P is formed, and at the rear of the suspension frame 34, an ejection port 34A for ejecting the sheet P is formed.

Furthermore, at the rear of the support frame 34, a pair of ejecting rollers 26 is provided to convey the sheet P, that is ejected from the ejection port 34A, toward the downstream side. Each ejecting roller 26 comprises a shaft extending in the left and right directions and a plurality of rollers fixed to the shaft at intervals in the left and right directions. As described in detail later, one roller constituting the ejecting roller 26 is connected to the drive motor M (see FIG. 3) via the fixing side drive transmitting section 40 and others, and rotates around its axis under the driving force (the rotational force) from the drive motor M. The other roller in the ejecting roller 26 rotates in response to rotation of the one roller. Furthermore, at a left end portion of the support frame 34, a support shaft portion 35 extending toward the left is provided, and in the side plate frame 33 at the left side, a support shaft opening 33A, through which the support shaft portion 35 and others penetrates, is formed (see FIG. 5).

### Fixing Holder

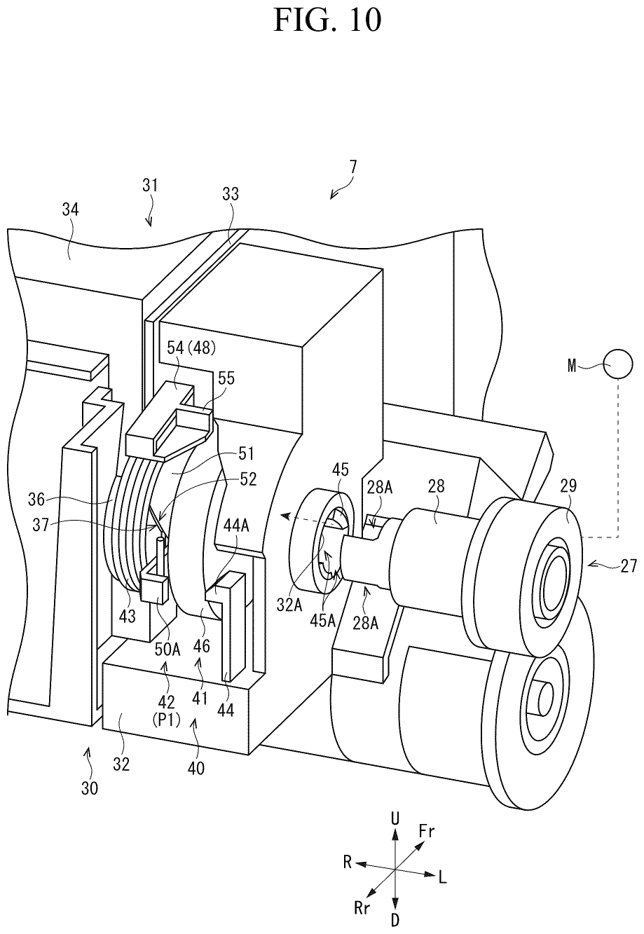

As shown in FIG. 2, the fixing holder 32 is attached to the side plate frame 33 at the left side of the fixing frame 31. The fixing holder 32 is formed, for example, from a synthetic resin possessing heat resistance and wear resistance, and is formed in a roughly U-shape (or a roughly C-shape) opening at the right side. The fixing holder 32 is provided so as to have a placement space between itself and the side plate frame 33 at the left side (one end face of the fixing frame 31 in the axial direction), and in the placement space, the fixing side drive transmitting section 40 is provided. Furthermore, in a side face of the fixing holder 32 facing the support shaft opening 33A of the side plate frame 33, a support hole 32A is formed (see FIG. 10).

### Fixing Side Drive Transmitting Section

The fixing side drive transmitting section 40 is connected to the ejecting roller 21, one roller of the pressuring rollers 21 and others. Furthermore, the fixing side drive transmitting section 40 is connected to the drive motor M via the main body side joint member 27 provided on the main body 2. The fixing side drive transmitting section 40 transmits the driving force from the drive motor M to the pressuring roller 21 and others.

### Fixing Process

Here, action (fixing process) of the fixing device 7 will be described. The control unit of the image forming apparatus 1 executes the fixing process as a part of the image forming process as follows. The drive motor M rotates the pressuring roller 21 around its axis, and the fixing belt 20 rotates in response to the pressuring roller 21 (see arrow in FIG. 4). The heater 22 heats the fixing belt 20 (in the pressuring area N).

When the fixing belt 20 (the heater 22) reaches a predetermined temperature, the control unit initiates the previously described image forming process. The sheet P, onto which the toner image has been transferred, enters the pressuring area N. The fixing belt 20 rotates around its axis while passing through the pressuring area N and heats the toner (the toner image) on the sheet P. The pressuring roller 21 applies pressure to the toner on the sheet P passing through the pressuring area N while rotating around its axis. This causes the toner image to be fixed to the sheet P, forming a fixed image on the sheet P. The sheet P with the fixed image is then ejected to the ejection tray 4.

Incidentally, the fixing device 7 may be detached from the main body 2 in a case of malfunction, maintenance or the like. Specifically, on the rear face of the main body 2, an openable cover 2A (see FIG. 1) is provided. An operator opens the cover 2A and pulls the fixing device 7 out rearward. Additionally, the operator reattaches the repaired fixing device 7 or a replacement fixing device 7 to the main body 2. When attaching or detaching the fixing device 7 to or from the main body 2, it is necessary to interrupt the transmission of the driving force (the rotational force) to components such as the pressuring roller 21. Furthermore, after mounting the fixing device 7 onto the main body 2, when executing the fixing process (the image forming process), it is necessary to transmit the driving force to the pressuring roller 21 and others. Therefore, the fixing device 7 according to this embodiment is provided with a structure (the fixing side drive transmitting section 40) for easily switching the transmission and interruption of the driving force to the pressuring roller 21.

### Structure of the Fixing Side Drive Transmitting Section

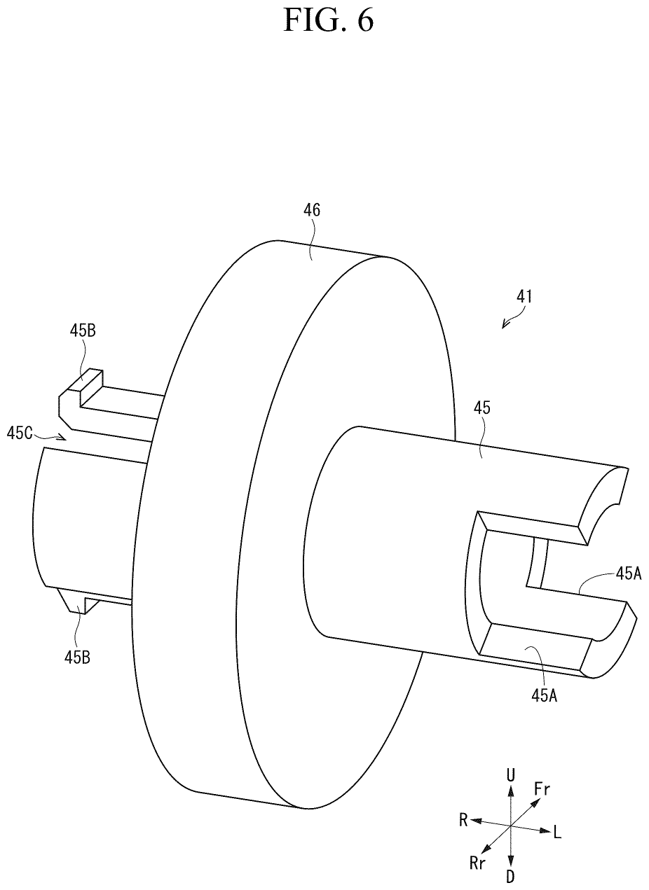

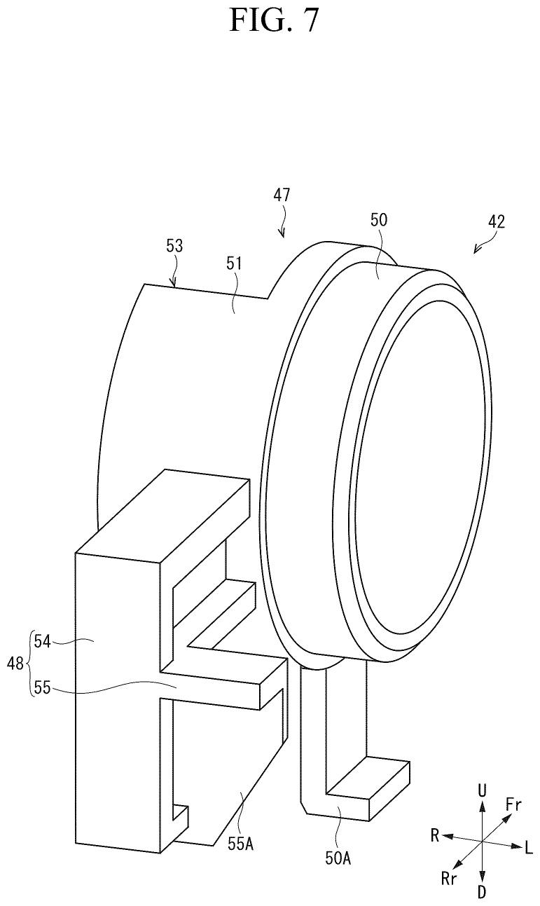

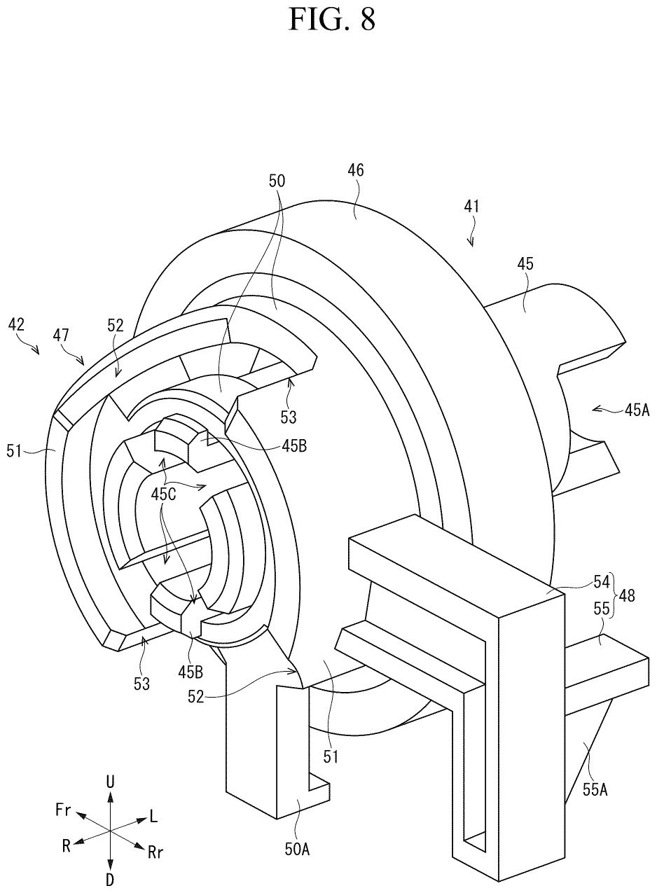

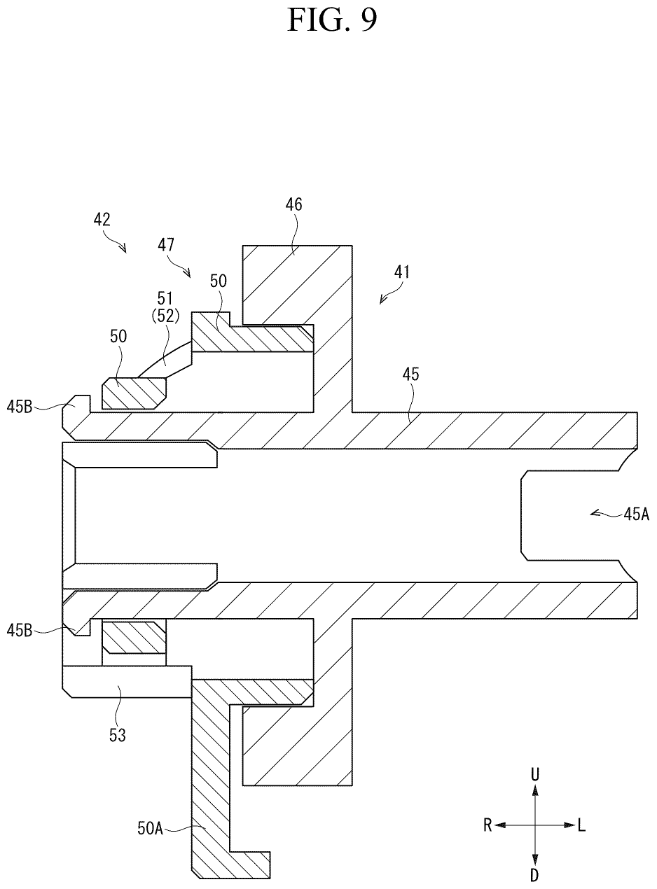

Referring to FIGS. 5-9, the structure of the fixing side drive transmitting section 40 will be described. FIG. 6 is a perspective view showing a fixing side joint member 41 of the fixing side drive transmitting section 40. FIG. 7 is a perspective view showing a lever member 42 of the fixing side drive transmitting section 40. FIG. 8 is a perspective view showing the fixing side joint member 41 and the lever member 42 of the fixing side drive transmitting section 40. FIG. 9 is a cross-sectional view showing the fixing side joint member 41 and the lever member 42 of the fixing side drive transmitting section 40. FIG. 10 is a perspective view showing the fixing side joint member 41 separated from the main body side joint member 27.

The fixing side drive transmitting section 40 comprises the fixing side joint member 41, the lever member 42, a biasing member 43, and a hook member 44. The fixing side joint member 41, the lever member 42, and the biasing member 43 are arranged within a placement space enclosed by the fixing holder 32. The hook member 44 is integrally formed with the fixing holder 32.

### Fixing Side Joint Member

As shown in FIG. 6, the fixing side joint member 41 comprises a fixing side shaft joint 45 and a fixing side gear 46. The fixing side shaft joint 45 and the fixing side gear 46 are integrally molded, for example, from a synthetic resin material possessing heat resistance and wear resistance.

### Fixing Side Shaft Joint

The fixing side shaft joint 45 is formed as a substantially cylindrical shape extending in the left and right directions (the axial direction). The fixing side shaft joint 45 is supported between the side plate frame 33 at the left side and the fixing holder 32, traversing the placement space in the left and right directions (the axial direction). Specifically, the support shaft portion 35 of the support frame 34 (see FIG. 5) is inserted into the right inner side of the fixing side shaft joint 45, while the left side of the fixing side shaft joint 45 is inserted into the support hole 32A of the fixing holder 32 (see FIG. 2). The fixing side shaft joint 45 is supported rotatably and slidably in the left and right directions (the axial direction) by the fixing frame 31 and the fixing holder 32. As described in detail later, the fixing side shaft joint 45 protrudes to the left side (outward in the axial direction) from the fixing holder 32 and connects to the main body side joint member 27.

On a left end portion of the fixing side shaft joint 45, a pair of fixing side engagement portions 45A are formed at positions facing to each other across its axial center. Each fixing side engagement portion 45A is notched from a left end of the fixing side shaft joint 45 toward the right side (from an outer end to the inner side in the axial direction). When the fixing side shaft joint 45 protrudes to the left side from the fixing holder 32, the pair of fixing side engagement portions 45A engage with the main body side joint member 27.

Furthermore, at a right end portion of the fixing side shaft joint 45, a pair of protrusions 45B protrude radially outward. The pair of protrusions 45B are formed in positions facing to each other across the axial center of the fixing side shaft joint 45. On both sides of each protrusion 45B in a circumferential direction, a pair of slits 45C are cut (see also FIG. 8). A portion partitioned by the pair of slits 45C (including the protrusions 45B) is formed to be radially elastically.

### Fixing Side Gear

The fixing side gear 46 is a spur gear sharing the same axial center as the fixing side shaft joint 45. The fixing side gear 46 is formed in a roughly cylindrical shape (roughly circular plate shape) with a closed left end face and an opened right end face. The fixing side gear 46 is fixed to the outer peripheral surface of the fixing side shaft joint 45 at a roughly central position in the left and right directions of the fixing side shaft joint 45. The pair of protrusions 45B described above are formed at positions spaced to the right (toward the inner side in the axial direction) from the fixing side gear 46. The fixing side gear 46 is connected to the pressuring roller 21, one roller of the pair of ejecting rollers 26 and others via a gear train (not shown) to transmit the rotational force to the pressuring roller 21 and others.

### Main Body Side Joint Member

Here, the main body side joint member 27, which is connected to the fixing side shaft joint 45, will be briefly described. As shown in FIG. 10, the main body side joint member 27 is positioned at the left side of the fixing device 7 (the fixing holder 32). The main body side joint member 27 has a structure similar to the fixing side shaft joint 45, for example, a main body side shaft joint 28 and a main body side gear 29 integrally molded from a synthetic resin material. The main body side shaft joint 28 is formed in a substantially cylindrical shape extending in the left and right directions and is supported rotatably around its axis on the main body 2. At a right end portion of the main body side shaft joint 28, a pair of main body side engagement portions 28A, which engage with the pair of fixing side engagement portions 45A protruding to the left side from the fixing holder 32, are notched. The main body side gear 29 is a spur gear and is provided to share the same axial center as the main body side shaft joint 28. The main body side gear 29 is connected to the drive motor M via a gear train (not shown).

### Lever Member

As shown in FIG. 7, the lever member 42 comprises a lever cylindrical portion 47 and a lever operating portion 48. The lever barrel portion 47 and the lever operating portion 48 are integrally molded, for example, from a synthetic resin material possessing heat resistance and wear resistance 40.

### Lever Cylindrical Portion

As shown in FIGS. 7 and 8, the lever cylindrical portion 47 comprises a cylindrical main body portion 50 and a pair of lever curved ribs 51. The cylindrical main body portion 50 is formed as a roughly cylindrical shape with both opened ends in the left and right directions. More specifically, the cylindrical main body portion 50 is formed as roughly cylindrical shape with steps by connecting two cylinders with different outer diameters in the left and right directions. The left side of the cylindrical main body 50 has an outer diameter that can be fitted inside the fixing side gear 46, and the right side of the cylindrical main body 50 is formed with a smaller diameter than the left side. The inner diameter of the left side of the cylindrical main body 50 is formed sufficiently larger than the outer diameter of the fixing side shaft joint 45. The inner diameter of the right side of the cylindrical main body 50 is formed slightly larger than the outer diameter of the fixing side shaft joint 45. Furthermore, on the left side (a large diameter portion) of the cylindrical main body 50, a lever side engagement portion 50A extending radially outward is formed.

The pair of lever curved ribs 51 extend to the right side from the right end of the large diameter portion of the cylindrical main body 50 and face to an outer peripheral surface of a small diameter portion of the cylindrical main body 50 with a gap. The pair of lever curved ribs 51 are arranged to face to each other across an axial center (center) of the cylindrical main body 50. The pair of lever curved ribs 51 are curved to form a part of an arc around the axial center of the cylindrical main body 50.

As shown in FIGS. 8 and 9, into an axial center portion of the lever cylindrical portion 47, the right side of the fixing side shaft joint 45 is inserted. The right end portion of the fixing side shaft joint 45 is inserted into the axial center portion of the lever cylindrical portion 47 while deflecting the pair of protrusions 45B radially inward. The lever cylindrical portion 47 is positioned between the fixing side gear 46 and each protrusion 45B. The left side (the large diameter portion) of the cylindrical main body 50 is fitted rotatably inside the fixing side gear 46, and the right side (the small diameter portion) of the cylindrical main body 50 is positioned rotatably on the outer peripheral surface of the fixing side shaft joint 45. The lever cylindrical portion 47 is supported rotatably along the outer peripheral surface of the fixing side shaft joint 45. Furthermore, the lever cylindrical portion 47 is supported along the outer peripheral surface of the fixing side shaft joint 45 such that it cannot slide in the left and right directions (the axial direction), and slides in the left and right directions integrally with the fixing side shaft joint 45 (the fixing side joint member 41).

### Details of Lever Curved Rib

As shown in FIG. 8, on one end face of each lever curved rib 51 in a circumferential direction (a rotation direction), a lever inclined surface portion 52, which is inclined toward the right side (toward the inner side in the axial direction) in a counterclockwise direction as viewed from the right side. On the other end face of each lever curved rib 51 in the circumferential direction, a lever contact surface portion 53, which is substantially parallel to the axial direction, is formed. The lever inclined surface portion 52 of one lever curved rib 51 and the lever contact surface portion 53 of the other lever curved rib 51 face to each other with a gap. That is, one lever curved rib 51 has a shape as if the other lever curved rib 51 were rotated 180 degrees around its axial center of the cylindrical main body portion 50.

### Support Curved Rib

Tips (right ends) of the pair of lever curved ribs 51 are positioned opposite a left end portion of the fixing frame 31 (see FIG. 10). As shown in FIG. 5, on the left end portion of the support frame 34, a pair of support curved ribs 36 extending toward the left are formed. The pair of support curved ribs 36 are provided facing to each other across the support shaft portion 35. The pair of support curved ribs 36 are curved to form a part of an arc, similar to the pair of lever curved ribs 51. On one end face of each support curved rib 36 in a circumferential direction (a rotation direction) (one end face of the fixing frame 31 in the axial direction), a support inclined surface portion 37, which is inclined toward the left side (toward the outer side in the axial direction) in a counterclockwise direction (from one side to the other side in the circumferential direction) as viewed from the left side. On the other end face of each support curved rib 36 in the circumferential direction, a support contact surface portion 38, substantially parallel to the axial direction, is formed. The support inclined surface portion 37 of one support curved rib 36 and the support contact surface portion 38 of the other support curved rib 36 face to each other with a gap. That is, one support curved rib 36 has a shape as if the other support curved rib 36 were rotated 180 degrees around the support shaft portion 35. The lever inclined surface portion 52 described above is inclined so as to be parallel to the support inclined surface portion 37 and is capable of making surface contact with the support inclined surface portion 37. In this specification, “surface contact” means a state where the lever inclined surface portion 52 and the support inclined surface portion 37 are in contact over substantially their entire surfaces.

### Lever Operating Portion

As shown in FIG. 7, the lever operating portion 48 extends radially outward from an outer peripheral surface of the lever cylindrical portion 47. Specifically, the lever operating portion 48 comprises an operating main body portion 54 and a hook engagement portion 55. The operating main body portion 54 comprises a horizontal section extending radially outward from one lever curved rib 51 and a vertical section extending downward from a tip of the horizontal section, and is formed in a substantially L-shape. The horizontal section of the operating main body portion 54 extends radially outward from a position shifted from the lever side engagement portion 50A by approximately 90 degrees in a circumferential direction. The hook engagement portion 55 protrudes to the left side from a left face of the vertical portion of the operating main body portion 54. Between the hook engagement portion 55 and the vertical portion of the operating main body portion 54, a roughly triangular reinforcing rib 55A is provided.

### Biasing Member

As shown in FIG. 10, the biasing member 43 is, for example, a torsion spring, and is wound around the pair of support curved ribs 36. One arm portion of the biasing member 43 engages with the side plate frame 33 at the left side, and the other arm portion engages with the lever side engagement portion 50A of the cylindrical main body portion 50. The biasing member 43 biases the lever member 42 clockwise as viewed from the left side.

### Hook Member

As shown in FIG. 10, the hook member 44 extends upward from a lower portion of a rear end of the fixing holder 32. The hook member 44 is formed as a substantially flat plate standing substantially vertically and is provided so that it can elastically deform in the left and right directions with its lower end portion serving as a pivot point. On an upper end of the hook member 44, a claw portion 44A protrudes toward the right side.

### Action of Fixing Side Drive Transmitting Section

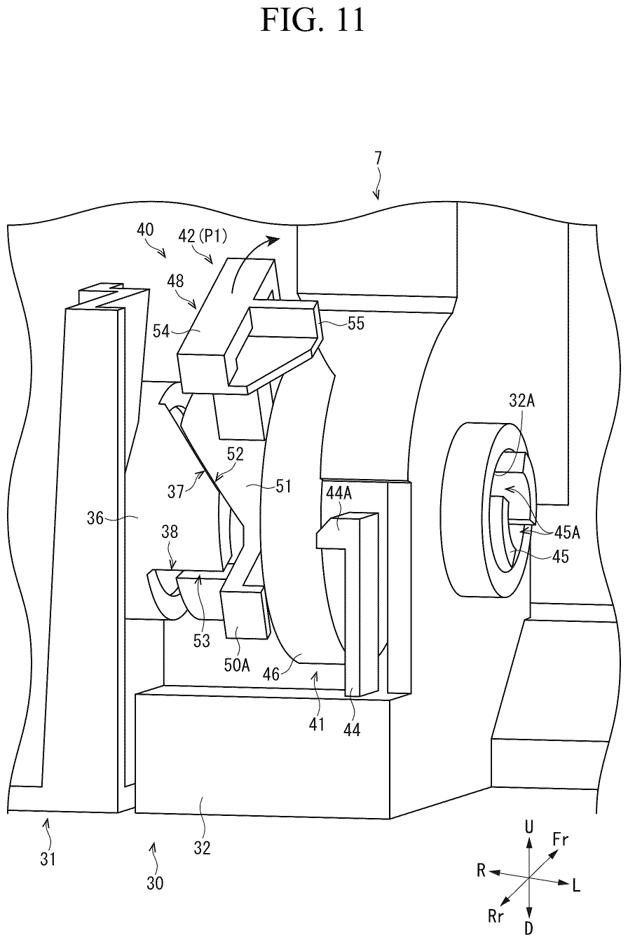

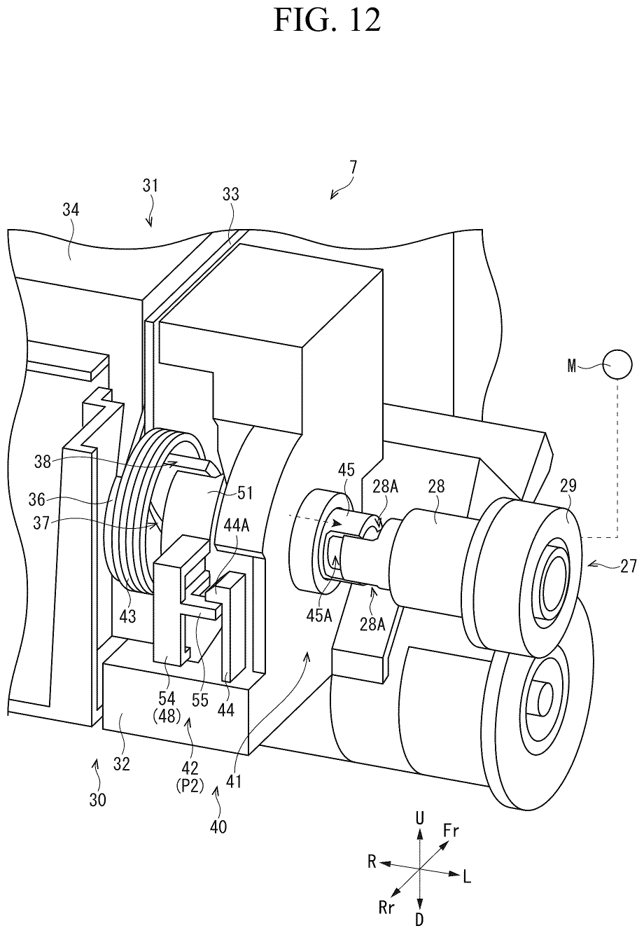

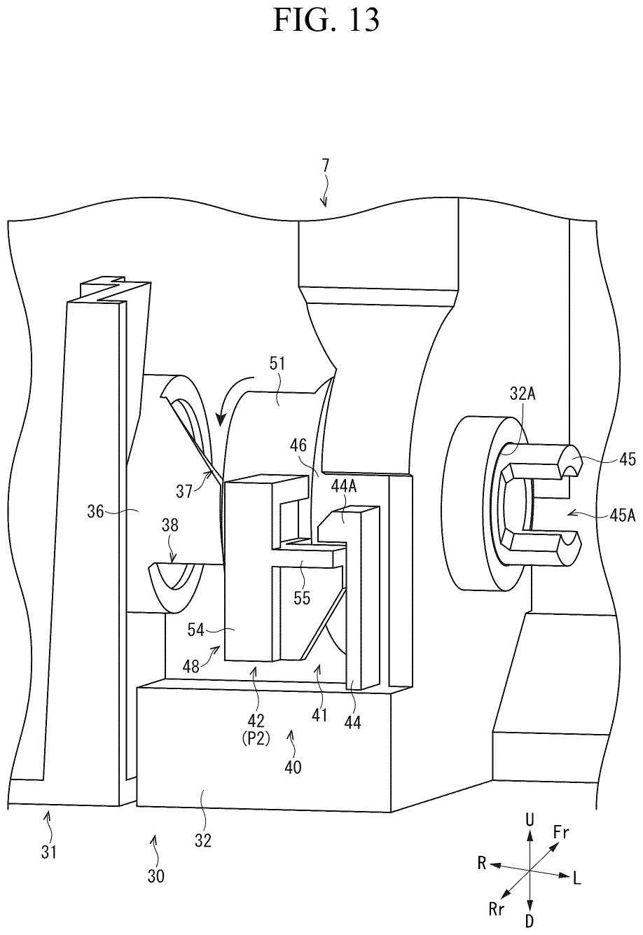

Referring to FIGS. 10-13, action of the fixing side drive transmitting section 40 will be described. FIG. 11 is a perspective view showing the fixing side drive transmitting section 40 in a state where the lever member 42 is positioned at a separated position P1. FIG. 12 is a perspective view showing the fixing side drive transmitting section 40 in a state where the fixing side joint member 41 connected to the main body side joint member 27. FIG. 13 is a perspective view showing the fixing side drive transmitting section 40 in a state where the lever member 42 is positioned at a connected position P2. Note that the biasing member 43 is omitted from FIGS. 11 and 13.

Here, a case where the operator attaches the fixing device 7 onto the main body 2 will be described. In a state where the fixing device 7 is detached from the main body 2, as shown in FIGS. 10 and 11, the lever member 42 is biased by the biasing member 43 and positioned in the separated position P1. The lever member 42 positioned in the separated position P1 is configured to have the lever operating portion 48 tilted diagonally upward and rearward. Therefore, the hook engagement portion 55 of the lever operating portion 48 is spaced apart upwardly from the claw portion 44A of the hook member 44. Furthermore, in the state where the lever member 42 is positioned at the separated position P1, each lever curved rib 51 of the lever member 42 is engaged between the pair of support curved ribs 36 of the fixing frame 31. The lever inclined surface portion 52 of the lever curved rib 51 contacts (surface contact) substantially the entire surface of the support inclined surface portion 37 of the support curved rib 36. The lever contact surface portion 53 of the lever curved rib 51 contacts (or faces to each other with a slight gap) substantially the entire surface of the support contact surface portion 38 of the support curved rib 36. Furthermore, substantially the entire of the fixing side joint member 41 is positioned within the placement space, and the pair of fixing side engagement portions 45A of the fixing side shaft joint 45 are positioned (embedded) within the support hole 32A.

### Attachment of Fixing Device

The operator opens the cover 2A of the main body 2 and attaches the fixing device 7 at a predetermined position inside the main body 2. Next, the operator hooks a finger onto the lever operating portion 48 (the operating main body portion 54) of the lever member 42 and pulls the lever operating portion 48 downward against the biasing force of the biasing member 43 (see arrow in FIG. 13). As a result, the lever member 42 rotates counterclockwise as viewed from the left side. The lever inclined surface portion 52, which was in face contact with the support inclined surface portion 37, is shifted in the rotation direction to reduce a contact area, and the pair of lever curved ribs 51, which were engaged between the pair of support curved ribs 36, disengage to the left side from between the pair of support curved ribs 36. The lever contact surface portion 53 of the lever curved rib 51 separates from the support contact surface portion 38 of the support curved rib 36 in the rotation direction. The lever member 42 rotates while contacting the lever inclined surface portion 52 with the support inclined surface portion 37, to slide to the left side and to press a side surface of the fixing side gear 46 to the left side, thereby sliding the fixing side joint member 41 to the left side. In other words, the fixing side joint member 41 slides to the left side integrally with the lever member 42 (see dashed arrow in FIG. 12). Then, a tip of the fixing side shaft joint 45 protrudes to the left side from the support hole 32A and engages with the pair of main body side engagement portions 28A of the main body side shaft joint 28 (see FIG. 12). Consequently, the fixing side joint member 41 is connected to the drive motor M via the main body side joint member 27, enabling it to transmit the rotational force to the pressuring roller 21. The lever member 42 is positioned at the connected position P2, where the fixing side joint member 41 is connected to the main body side joint member 27 (see FIGS. 12 and 13). A gear meshing with the fixing side gear 46 is a spur gear with a thickness corresponding to a slide range of the fixing side gear 46.

Furthermore, as the lever operating portion 48 is pulled downward, the hook engagement portion 55 of the lever operating portion 48 contacts the upper end portion (the claw portion 44A) of the hook member 44 to climb over the claw portion 44A while deflecting the hook member 44 to the left side. When the lever member 42 is positioned at the connected position P2, the claw portion 44A of the hook member 44 engages with an upper end of the hook engagement portion 55 to hold the lever member 42 at the connected position P2 (see FIGS. 12 and 13). A lower end portion of the vertical portion of the operating main body portion 54 contacts a lower portion of the fixing holder 32 to restrict downward pull (rotation) of the lever member 42.

Thus, the fixing device 7 is attached onto the main body 2. The operator then closes the cover 2A of the main body 2.

### Detachment of the Fixing Device

Next, when detaching the fixing device 7 from the main body 2, the operator opens the cover 2A of the main body 2, deflects the hook member 44 to the left side, and disengages the claw portion 44A from the hook engagement portion 55. This causes the biasing member 43 to bias the lever member 42 positioned at the connected position P2 toward the separated position P1. The lever member 42 rotates clockwise as viewed from the left side (it is flipped up; see arrow in FIG. 11). The lever inclined surface portion 52 is shifted circumferentially to increase its contact area with the support inclined surface portion 37, and the pair of lever curved ribs 51 engage between the pair of support curved ribs 36. The lever member 42 rotates while keeping the lever inclined surface portion 52 in contact with the support inclined surface portion 37 to slide to the right side and to press the pair of projections 45B of the fixed side shaft joint 45 toward the right, thereby sliding the fixed side joint member 41 to the right side. That is, the fixing side joint member 41 slides integrally with the lever member 42 to the right side (see arrow in FIG. 10). Then, the tip (the pair of fixing side engagement portions 45A) of the fixing side shaft joint 45 is embedded in the support hole 32A and is separated from the pair of main body side engagement portions 28A of the main body side shaft joint 28 (see FIG. 10). The lever contact surface portion 53 of the lever curved rib 51 contacts the support contact surface portion 38 of the support curved rib 36, thereby restricting the rotation of the lever member 42 (see FIG. 11). This interrupts transmission of the rotational force from the drive motor M, positioning the lever member 42 at the separation position P1.

As a result, the fixing device 7 becomes in a state where it can be detached from the main body 2. The operator detaches the fixing device 7 from the main body 2 and performs predetermined workings such as maintenance.

In the fixing device 7 of the present embodiment described above, the lever member 42 rotates counterclockwise as viewed from the left side (from one side to other side in the rotation direction) while contacting the support inclined surface portion 37, thereby sliding the fixing side joint member 41 to the left side (from the inner side to the outer side in the axial direction) and positioning it at the connected position P2, where it is connected to the main body side joint member 27. When the lever member 42 rotates clockwise as viewed from the left side (from the other side to the one side in the rotation direction) while contacting the support inclined surface portion 37, thereby sliding the fixing side joint member 41 to the right side (from the outer side to the inner side in the axial direction) and positioning it at the separated position P1, where it is separated from the main body side joint member 27. According to this configuration, reciprocating the lever member 42 allows the fixing side joint member 41 to be connected to or separated from the main body side joint member 27, enabling easy switching between transmitting and interrupting the driving force to the pressuring roller 21.

Furthermore, in the fixing device 7 of this embodiment, the biasing member 43 biases the lever member 42 toward the separated position P1, enabling the lever member 42 to be held in the separated position P1. This facilitates smooth attachment and detachment of the fixing device 7 to and from the main body 2. Furthermore, since the hook member 44 engages with the lever member 42 positioned at the connected position P2 and the lever member 42 is held at the connected position P2, the fixing side joint member 41 can be held in a state connected to the main body side joint member 27. This ensures stable fixing process by the fixing device 7.

In the fixing device 7 of this embodiment, the fixing side shaft joint 45 and the fixing side gear 46 are integrated to form the fixing side joint member 41. This configuration can reduce the number of parts compared to a case where the fixing side shaft joint 45 and the fixing side gear 46 are separate components. When attaching or detaching the fixing device 7 to or from the main body 2, the operator can rotate the lever member 42 by operating the lever operating portion 48. Furthermore, when the lever member 42 is positioned at the connected position P2, the lever operating portion 48 engages with the hook member 44. This eliminates the need to provide a dedicated engagement portion on the lever member 42 for engaging with the hook member 44, allowing for a simpler structure of the lever member 42.

In the fixing device 7 of this embodiment, a biasing member 43 is provided to bias the lever member 42 toward the separated position P1, however, the present disclosure is not limited thereto, and the biasing member 43 may be omitted (not shown). Furthermore, in the fixing device 7 according to this embodiment, a hook member 44 is provided to hold the lever member 42 in the connected position P2, however, the present disclosure is not limited thereto, and the hook member 44 may be omitted (not shown). In these cases, the operator may manually reciprocate the lever member 42. Furthermore, when the hook member 44 is omitted, the hook engagement portion 55 and the reinforcing rib 55A of the lever operating portion 48 may also be omitted (not shown).

Furthermore, in the fixing device 7 of this embodiment, the lever cylindrical portion 47 had the lever inclined surface portion 52 that was parallel to the support inclined surface portion 37 of the fixing frame 31, however, the present disclosure is not limited thereto. The lever cylindrical portion 47 may have a protrusion (not shown) that moves while contacting the support inclined surface portion 37, instead of the lever curved rib 51 or the lever inclined surface portion 52. In this case, a tip of the protrusion is formed to be substantially hemispherical, and the protrusion contacts the support inclined surface portion 37 at a single point.

Furthermore, in the fixing device 7 of this embodiment, a fixing belt 20 is adopted as one example of the fixing member, however, the present disclosure is not limited thereto. For example, a fixing roller (not shown) rotating about a shaft may also be adopted as the fixing member. Furthermore, in the fixing device 7 of this embodiment, the pressuring roller 21 rotates by the driving force, and the fixing belt 20 rotates in response to rotation of the pressuring roller 21, however, the present disclosure is not limited thereto. Conversely, the fixing belt 20 may rotate by the driving force, and the pressuring roller 21 may rotate in response to rotation of the fixing belt 20.

Furthermore, the description of the above embodiment illustrates one example that the present disclosure is applied to the monochrome image forming apparatus 1, however, the present disclosure is not limited thereto, and the present disclosure may be applied to a color printer, a copying machine, a facsimile, a multifunction peripheral, or the like.

The description of the above embodiment illustrates one aspect of the fixing device and the image forming apparatus according to the present disclosure, and the scope of the present disclosure is not limited to the above embodiment. The present disclosure may be variously modified, substituted, or transformed without departing from the spirit of the technical concept, and the claims encompass all embodiments that may fall within the scope of the technical concept.

What is claimed is:

1. A fixing device comprising:
a fixing member heating a toner on a medium while rotating around its axis;
a pressuring member, that forms a pressuring area between the fixing member and the pressuring member, pressuring the toner on the medium passing through the pressuring area while rotating around its axis;
a fixing support member supporting rotatably the fixing member and the pressuring member;
a fixing side joint member being supported rotatably and slidably in an axial direction on the fixing support member, being connected to a drive source via a main body side joint member, and transmitting rotational force to either the fixing member or the pressuring member; and
a lever member being supported rotatably on the fixing side joint member and slidable in the axial direction integrally with the fixing side joint member,
wherein the fixing support member has an inclined surface portion that is inclined outward in the axial direction from one side of other side in a rotation direction,
when the lever member rotates from the one side to the other side in the rotation direction while contacting the inclined surface portion, the fixing side joint member is slidden from an inner side to an outer side in the axial direction and is positioned at a connected position where it is connected to the main body side joint member,
when the lever member rotates from the other side of the one side in the rotation direction while contacting the inclined surface portion, the fixing side joint member is slidden from the outer side to the inner side in the axial direction and is positioned at a separated position where it is separated to the main body side joint member.

2. The fixing device according to claim 1, further comprising:
a biasing member biasing the lever member toward the separated position; and
a hook member engaging with the lever member positioned at the connected position to hold the lever member at the connected position.

3. The fixing device according to claim 2, wherein
the fixing support member comprises:
a fixing frame supporting rotatably the fixing member and the pressuring member; and
a fixing holder provided so as to have a placement space, where the fixing side joint member and the lever member are positioned, between itself and one end face in the axial direction of the fixing frame, and in the placement space,
the fixing side joint member comprises:
a fixing side shaft joint traversing the placement space in the axial direction, being supported rotatably and slidably in the axial direction by the fixing frame and the fixing holder, and protruding outward in the axial direction from the fixing holder to connect to the main body side joint member; and
a fixing side gear being fixed to an outer peripheral surface of the fixing side shaft joint and transmitting rotational force to either the fixing member or the pressuring member,
the lever member comprises:
a lever cylindrical portion supported rotatably along the outer peripheral surface of the fixing side shaft joint; and
a lever operating portion extending radially outward from an outer peripheral surface of the lever cylindrical portion,
the inclined surface portion is formed on the one end face in the axial direction of the fixing frame,
the fixing side shaft joint has a protrusion being spaced inward in the axial direction from the fixing side shaft joint and extending radially outward from the fixing side gear,
the lever cylindrical portion is supported rotatably on the fixing side shaft joint between the fixing side gear and the protrusion such that it cannot slide in the axial direction,
the lever cylindrical portion has a lever inclined surface portion being inclined to be parallel to the inclined surface portion and being capable of surface contact with the inclined surface portion.

4. The fixing device according to claim 3, wherein
when the lever member is positioned at the connected position, the lever operating portion engages with the hook member.

5. The fixing device according to claim 3, wherein
the fixing holder has a support hole,
when the lever member is positioned at the separated position, the fixing side shaft joint is inserted into the support hole,
when the lever member is positioned at the connected position, the fixing side shaft joint protrudes outward in the axial direction from the support hole.

6. An image forming apparatus comprising:
the fixing device according to claim 1.
